(19) United States
(12) Patent Application Publication
(10) Pub. No.: US 2018/0189148 A1
(43) Pub. Date: Jul. 5, 2018

(54) MULTIPLE DATA PROTECTION SCHEMES FOR A SINGLE NAMESPACE

(71) Applicant: Intel Corporation, Santa Clara, CA (US)

(72) Inventors: Ian F. Adams, Hillsboro, OR (US); Michael P. MESNIER, Scappoose, OR (US); Arun RAGHUNATH, Hillsboro, OR (US)

(21) Appl. No.: 15/395,922

(22) Filed: Dec. 30, 2016

(51) Int. Cl. G06F 11/14; G06F 17/30

(52) U.S. Cl. CPC G06F 11/1464; G06F 2201/82; G06F 17/30082

(57) ABSTRACT

A multiple data protection scheme logic enables applications to use objects encoded with different data protection schemes in a single namespace. Instead of configuring data protection policy supporting only one data protection scheme in a single namespace, flexible data protection policies that allow different data protection schemes in the single namespace promote more efficient use of storage and processor resources. Smaller objects can use data protection schemes that favor more efficient processor performance over increased storage costs such as replication, whereas larger objects can use data protection schemes that favor decreased storage costs over less efficient processor performance such as erasure coding.

### TECHNICAL FIELD

The technical field relates generally to object storage systems and, in particular, to data protection for object storage systems.

### BACKGROUND ART

Storage systems protect against loss and inconsistency of stored data using various data protection schemes, such as replication, RAID and erasure coding. For example, storage systems use replication to maintain redundant copies (replicas) of stored data, particularly for stored data that is operationally critical. RAID, or redundant array of independent disks, is a data storage virtualization technology that combines multiple physical disk drive components into a single logical unit for the purposes of data redundancy, performance improvement, or both. Erasure coding (EC), transforms a single piece of data into a series of shards containing redundant data that can later be used to reconstruct the single piece of data even if only a subset of the shards can be retrieved. For example, if an EC encoding function transforms the single piece of data into 10 shards, the storage system can recover the single piece of data even if only 8 shards are available.

Traditionally, object stores have used different data protection schemes to address various aspects of data protection, including reliability, durability and availability of data. Each type of data protection scheme has its own set of strengths and weaknesses.

For example, data replication offers simplicity but at the cost of high storage overhead. Erasure coding avoids the need to replicate data, thereby reducing overhead while maintaining data protection for larger objects. However, erasure coding incurs significant performance penalties when processing small objects in object storage, such as increased processor load, file system overhead, and increased network traffic. Since small objects statistically make up the dominant fraction of unique objects stored in storage systems but consume only a small fraction of the actual space, replication for small object data protection is preferable over erasure coding.

### BRIEF DESCRIPTION OF THE DRAWINGS

The described embodiments are illustrated by way of example and not limitation in the figures of the accompanying drawings, in which like references indicate similar elements and in which:

FIG. 1 is a block diagram illustrating a general overview of multiple data protection schemes in a single namespace in accordance with one embodiment;

FIG. 2 is a block diagram illustrating an overview of storing objects in an object storage system using multiple data protection schemes in a single namespace in accordance with one embodiment;

FIG. 3 is a block diagram illustrating an overview of retrieving objects from an object storage system using multiple data protection schemes in a single namespace in accordance with one embodiment;

FIGS. 4-5 are flow diagrams illustrating embodiments of processes performed in an object storage system supporting multiple data protection schemes in a single namespace accordance with one embodiment;

FIG. 6 is a chart illustrating example comparisons of the varying number of replicas and erasure coded fragments stored in an object storage system using multiple data protection schemes in accordance with embodiments shown in FIGS. 1-5;

FIG. 7 is a chart illustrating example comparisons of the varying number of bytes consumed in an object storage system using multiple data protection schemes in accordance with embodiments shown in FIGS. 1-5;

FIG. 8 illustrates an example of a typical computer system in which embodiments of multiple data protection schemes as described herein could be implemented in object storage systems, either in whole or in part.

Other features of the described embodiments will be apparent from the accompanying drawings and from the detailed description that follows.

### DESCRIPTION OF THE EMBODIMENTS

Current modern object storage systems cannot combine replicated objects and erasure coded objects in the same namespace, instead using separate namespaces and placements functions for each type of data protection. For this reason, object storage systems that use different data protection schemes for different types of objects, e.g. replication for small objects and erasure coding for larger objects, require users and applications to be aware of a particular object's data protection scheme, and carefully divide their workloads among separate namespaces. Alternatively, users and applications simply pay the respective cost of implementing a data protection policy limited to using one data protection scheme for all objects in a namespace by choosing one data protection scheme over another and hope for the best.

An application using a namespace that uses only erasure coding suffers potentially severe performance and file system overhead penalties (many shards, many small network packets, etc.) when there are many small objects. Conversely, an application using a namespace that uses only replication suffers from significant storage overhead, especially for larger objects. Because of these inefficiencies applications are forced to separate their namespaces, thereby burdening developers, or pay the cost of non-optimal storage for large fractions of data, potentially slowing down the entire scale-out system.

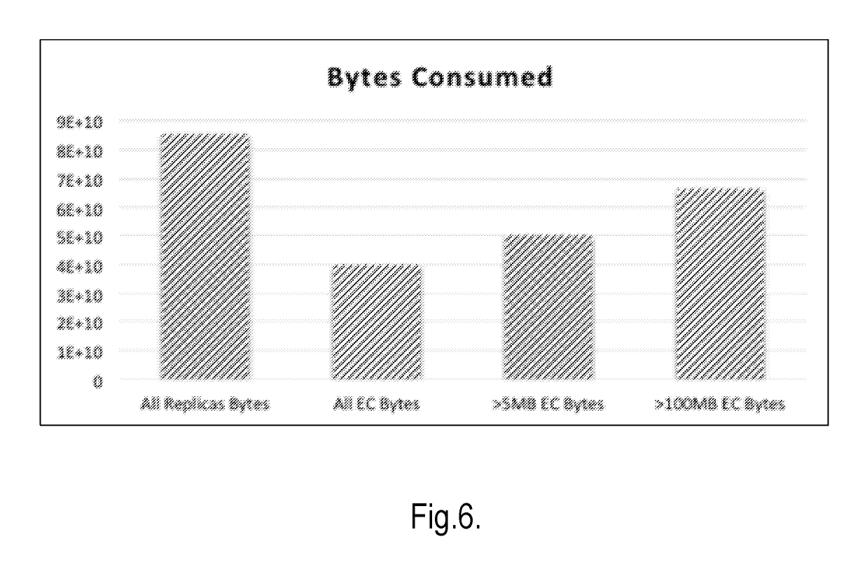

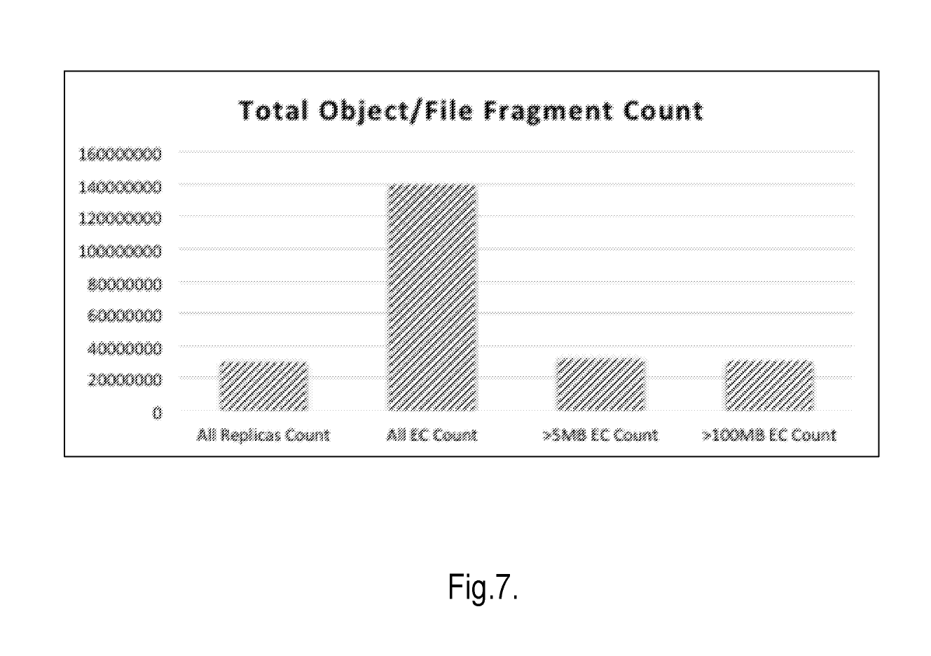

For example, using the open source object storage system Openstack Swift with a real world distribution of object sizes over 10 million objects, the charts in FIGS. 6 and 7 compare a 10+4 erasure coding scheme (14 total shards, a common scheme) with triple replication scheme in terms of total bytes stored (FIG. 6) and individual replicas/shards (files) stored (FIG. 7).

As shown, if a storage administrator decides to erasure code (referred to herein as EC) every object or replicate (referred to herein as RP) every object, the storage and performance compromises are readily apparent. While EC is the clear winner in bytes stored, at 4E+10 bytes consumed as compared to nearly 9E+10 bytes consumed for RP, there are over four times the number of object/file fragment counts (140M vs. 300M), which heavily burdens performance of the storage system's underlying file systems.

However, when applying EC to objects over 5 megabytes in size, the object storage system gleans 80% of the space savings (5E+10 bytes consumed instead of 9E+10 bytes), while creating less than 25% of the low-level files (25% over the 30000000) that would occur from a naïve all-EC approach. Hence, there is a significant performance and efficiency improvement in object storage systems if applications can take advantage of such differential data protection schemes in a single namespace.

In view of the significant advantages to using different data protection schemes for different types objects in an object storage system, the described embodiments provide a system for facilitating the use of multiple data protection schemes in a single namespace.

In the description that follows, examples may include subject matter such as a method, a process, a means for performing acts of the method or process, an apparatus, a node, and a system for multiple data protection schemes in a single namespace, and at least one machine-readable tangible storage medium including instructions that, when performed by a machine or processor, cause the machine or processor to performs acts of the method or process according to embodiments and examples described herein.

Numerous specific details are set forth to provide a thorough explanation of embodiments of the methods, media and systems for providing multiple data protection schemes in a single namespace. It will be apparent, however, to one skilled in the art, that an embodiment can be practiced without one or more of these specific details. In other instances, well-known components, structures, and techniques have not been shown in detail so as to not obscure the understanding of this description.

Reference in the specification to “one embodiment” or “an embodiment” means that a particular feature, structure, or characteristic described in connection with the embodiment can be included in at least one embodiment. The appearances of the phrase “in one embodiment” in various places in the specification do not necessarily all refer to the same embodiment.

The methods, processes and logic depicted in the figures that follow can comprise hardware (e.g. circuitry, dedicated logic, etc.), software (such as is run on a general-purpose computer system or a dedicated machine, e.g. an object store of file server), and interfaces, such as application programming interface (“API”)) between hardware and software, or a combination of both. Although the processes and logic are described below in terms of some sequential operations, it should be appreciated that some of the operations described can be performed in a different order. Moreover, some operations can be performed in parallel rather than sequentially.

In any one or more of the embodiments of the systems, apparatuses and methods herein described, a processor of a storage system for storing objects, the processor in communication with an application operating on objects in a namespace by name, configures a data protection policy for storing objects protected with different types of data protection schemes in the namespace, generates a set of locations for use with the namespace, the set of locations for operating on objects irrespective of which data protection scheme the object is protected with, and manages requests from the application operating on objects in the namespace, including requests to store and retrieve objects in accordance with the configured data protection policy for objects protected with different data protection schemes in the namespace.

In any one or more of the embodiments of the systems, apparatuses and methods herein described, the processor configures the data protection policy for objects protected with different data protection schemes in the namespace including receiving a specification of each one of multiple data protection schemes enabled for use in the namespace, the specification including a threshold size of objects governing which one of multiple data protection schemes to use for encoding and decoding objects. The processor configures a data protection policy for objects protected with different data protection schemes in the namespace further including specifying an indicator for overriding the threshold size of objects that would otherwise govern which one of the multiple data protection schemes to use for encoding and decoding objects in the storage system, the indicator specifying none or a particular one of the multiple data protection schemes.

In any one or more of the embodiments of the systems, apparatuses and methods herein described, the processor receives a request to use an object in the namespace and selects an object placement function for generating a same set of locations for the object each time the object is used in the namespace, and load-balances the processing of the object for the namespace, including generating additional hashing of the set of locations generated for the object to place the object pseudo-randomly within the same set of locations.

In any one or more of the embodiments of the systems, apparatuses and methods herein described, the processor stores the object in the object storage system by inspecting a size of the object, comparing the size of the object with the threshold size governing which one of the multiple data protection schemes to use for storing objects in the storage system, tagging the object with a selected one of the multiple data protection schemes based on whether the compared size of the object is within or exceeds the threshold size, and storing the object using the same set of locations generated for the object and in accordance with the selected one of the multiple data protection schemes with which the object is tagged.

In any one or more of the embodiments of the systems, apparatuses and methods herein described, objects within the threshold size use one of the multiple data protection schemes favoring more efficient processor performance over increased storage costs and objects exceeding the threshold size use one of the multiple data protection schemes favoring decreased storage costs over less efficient processor performance, where encodings favoring more efficient processor performance over increased storage costs include replication, and encodings favoring decreased storage costs over less efficient processor performance include erasure coding.

In any one or more of the embodiments of the systems, apparatuses and methods herein described, the processor retrieves the object from the object storage system, including retrieving the object specified in the request from one of a first number of locations in the same set of locations generated for the object, wherein the first number of locations is any one of a number of possible replicas or a number of possible shards for the object, determining which one of the multiple data protection schemes with which the object is tagged, retrieving only if necessary any one or more additional objects related to the retrieved object, wherein retrieving only if necessary is based on the determined one of the multiple data protection schemes with which the object is tagged.

In any one or more of the embodiments of the systems, apparatuses and methods herein described, the determined one of the multiple data protection schemes with which the object is tagged is erasure coding and the any one or more additional objects related to the retrieved object are shards necessary for reconstructing data for the object stored using erasure decoding.

In any one or more of the embodiments of the systems, apparatuses and methods herein described, an object store containing objects encoded with or capable of being encoded with different ones of a plurality of data protection schemes, namespaces for accessing objects in the object store by name, and a processor in communication with one or more applications operating on objects in a single namespace, are configured to identify one of the plurality of data protection schemes with which an object is efficiently encoded, generate a set of locations for use with the single namespace, the set of locations for operating on the object irrespective of the identified one of the plurality of data protection schemes with which the object is efficiently encoded, and manage requests from the application to operate on the object in the single namespace according to the identified one of the plurality of data protection schemes with which the object is efficiently encoded.

In any one or more of the embodiments of the systems, apparatuses and methods herein described, the processor receives any one or more pre-defined threshold sizes of objects used to identify ones of the plurality of data protection schemes with which objects are efficiently encoded, including identifying one of the plurality of data protection schemes with which an object is efficiently encoded by inspecting a size of the object, comparing the size of the object with a pre-defined threshold size, and tagging the object with a selected one of the plurality of data protection schemes based on whether the compared size of the object is within or exceeds the pre-defined threshold size.

In any one or more of the embodiments of the systems, apparatuses and methods herein described, data protection schemes with which an object is efficiently encoded include data protection schemes favoring more efficient processor performance over increased storage costs, and data protection schemes favoring decreased storage costs over less efficient processor performance. Objects whose compared size is within the pre-defined threshold size use one of the plurality of data protection schemes favoring more efficient processor performance over increased storage costs and objects whose compared size exceeds the threshold size use one of the plurality of data protection schemes favoring decreased storage costs over less efficient processor performance.

In any one or more of the embodiments of the systems, apparatuses and methods herein described, data protection schemes favoring more efficient processor performance over increased storage costs include replication, and data protection schemes favoring decreased storage costs over less efficient processor performance include erasure coding.

In any one or more of the embodiments of the systems, apparatuses and methods herein described, the processor is configured to receive an override indicator to override the any one or more pre-defined threshold sizes of objects that would otherwise identify the one of the plurality of data protection schemes with which an object is efficiently encoded, the override indicator specifying none or a particular one of the plurality of data protection schemes to use instead of the identified one of the plurality of data protection schemes.

In any one or more of the embodiments of the systems, apparatuses and methods herein described the processor generates a set of locations for use with the single namespace, the set of locations for operating on the object irrespective of the identified one of the plurality of data protection schemes with which the object is efficiently encoded, and selects an object placement function to generate a same set of locations for use with the single namespace every time the application uses the object, including load-balancing the application's use of the object, including generating additional hashing of the same set of locations to place the object pseudo-randomly within the same set of locations.

In any one or more of the embodiments of the systems, apparatuses and methods herein described, the processor manages requests from the application to operate on the object in the single namespace according to the identified one of the plurality of data protection schemes with which the object is efficiently encoded, including receiving a request from one or more applications to any one of access and retrieve the object in the single namespace; and, processing process the received request using the generated set of locations for use with the single namespace according to the identified one of the plurality of data protection schemes with which the object is efficiently encoded.

In any one or more of the embodiments of the systems, apparatuses and methods herein described, the processor retrieves the object from one of a first number of locations in the generated set of locations, wherein the first number of locations is any one of a number of possible replicas or a number of possible shards for the object, determines which one of the plurality of data protection schemes with which the object is tagged; retrieving only if necessary any one or more additional objects related to the retrieved object, wherein retrieving only if necessary is based on the determined one of the plurality of data protection schemes with which the object is tagged.

In any one or more of the embodiments of the systems, apparatuses and methods herein described, the determined one of the multiple data protection schemes with which the object is tagged is erasure coding and the any one or more additional objects related to the retrieved object are shards necessary for reconstructing data for the object stored using erasure decoding.

In one embodiment, an object storage system leverages an inherent order of a list of locations for storing objects returned by an object placement function. The same list of locations is used to store and retrieve objects regardless of their data protection, whether replication (RP) or erasure coding (EC), thereby avoiding the need for separate namespaces.

In the description that follows, references to objects are interchangeable with any type of files, fragments, or any other type of data capable of being made more reliable with one or more types data protection, including the aforementioned EC and RP data protection schemes.

In the description that follows, references to multiple data protection schemes are to the RP (replication) or EC (erasure coding) data protection schemes. However, references to multiple data protection schemes can also refer to more than two data protection schemes, including other data protection schemes that exhibit disparate storage performance profiles that vary with the size of objects similar to those exhibited by the described RP and EC data protection schemes. In other words, other data protection schemes that currently exist or are yet to be developed could also be used in accordance with the described embodiments of the system for facilitating the use of multiple data protection schemes in a single namespace.

In one embodiment, a selected object placement function deterministically creates a shared list of locations for storing all objects regardless of data protection scheme rather than one object location (or set of locations) for each namespace/data protection scheme. For example, instead of creating one set of locations for namespace A using RP data protection and another set of locations for namespace B using EC data protection, the selected object placement function creates only one shared set of locations for storing both RP and EC objects used in a single namespace C. The selected object placement function can be any one of a plurality of known object placement functions as long as the function consistently and deterministically creates a list of locations for storing objects that are subject to data protection.

In one embodiment, the shared list of locations is an ordered, pseudo-random list of locations at which objects encoded with any type of data protection can be stored in an object storage system. Other types of lists of locations can be used as long as the list has an inherent order or is otherwise associated with an identifiable order of locations at which objects can be stored in in the object storage system.

In one embodiment, a multiple data protection scheme logic determines whether an object is an EC or RP protected object when uploaded to the object storage system. A multiple data protection scheme logic inspects any one or more of a size and a user-provided tag or other type of indicator to make the determination.

In one embodiment, a multiple data protection scheme logic makes the determination by comparing the size of the object to a size threshold. The size threshold is a pre-defined cutoff size of an object (e.g. an amount of bytes) that dictates when to use EC or RP data protection. In a typical scenario larger numbers of smaller sized objects are tagged for RP and smaller numbers of larger sized objects are tagged for EC to achieve greater storage efficiency and improved performance. In one embodiment, the pre-defined cutoff size may be set by an administrator of the object storage system or programmatically determined. In a typical embodiment, the pre-defined cutoff size can be dynamically set or customized to suit the operational needs and conditions of the object storage system in which it is used. In one embodiment, a pre-defined size threshold can be used where three or more data protection schemes are used in a single namespace. For example the pre-defined size threshold could be expressed as a range of sizes for objects that are small, medium and large-sized objects corresponding to three different data protection schemes.

In one embodiment, the user-provided tag or other indicator specifying one of RP and EC type data protection schemes can be used to override the determination based on the comparison to the pre-defined size threshold that would otherwise govern whether an object uses EC or RP data protection.

In one embodiment, once the data protection is determined and the object appropriately tagged, e.g. EC or RP, a multiple data protection scheme logic uses the shared list of storage locations for storing the object regardless of the type of data protection with which the object is tagged.

In one embodiment, the tagging of the object is implemented in an extra piece of metadata appended to the object, the metadata indicating whether the object is erasure coded (EC) or replicated (RP). Other methods of tagging the object may be used as long as it conveys to the object storage system inspecting the object which type of data protection to use.

In one embodiment, during object retrieval, a stored object is optimistically assumed to be replicated with only a single replica retrieved. If, upon retrieval, a multiple data protection scheme logic confirms the object is replicated (e.g. by inspecting the object tag or other information obtained about the object), the single replica object retrieval operation is complete and no further processing is necessary.

In one embodiment, if a multiple data protection scheme logic instead determines that the retrieved object is a single shard of a larger object that has been erasure coded (e.g. by inspecting the object tag having a value of “EC”), the logic initiates additional retrieval operations to obtain the remaining shards needed to reconstruct the stored object. As such, the cost of retrieving a larger object is amortized over the additional retrieval operations for the larger object's remaining shards.

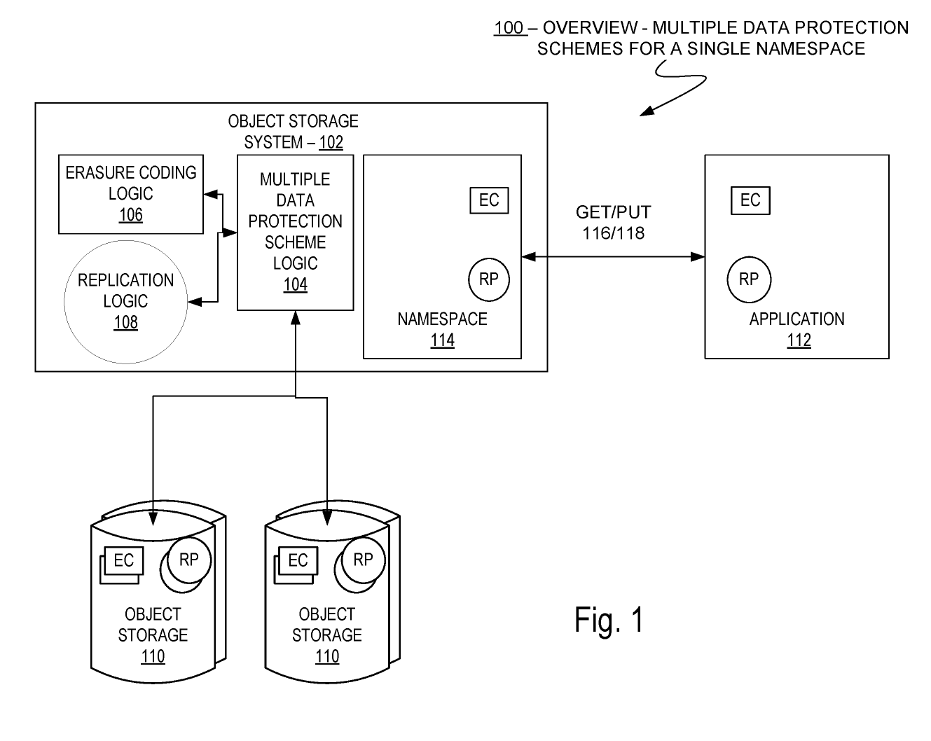

FIG. 1 illustrates an overview 100 of a system for multiple data protection schemes in a single namespace in accordance with one embodiment. An object storage system 102 includes a multiple data protection scheme logic 104 for supporting any two or more data protection schemes, such as an EC encoding scheme 106 and an RP encoding scheme 108. The object storage system 102 services an application 112 interacting with a single namespace 114 through the use of operations such as GET operations 116 and PUT operations 118. The objects can be stored in any one of a number of locations on object storage repositories 110.

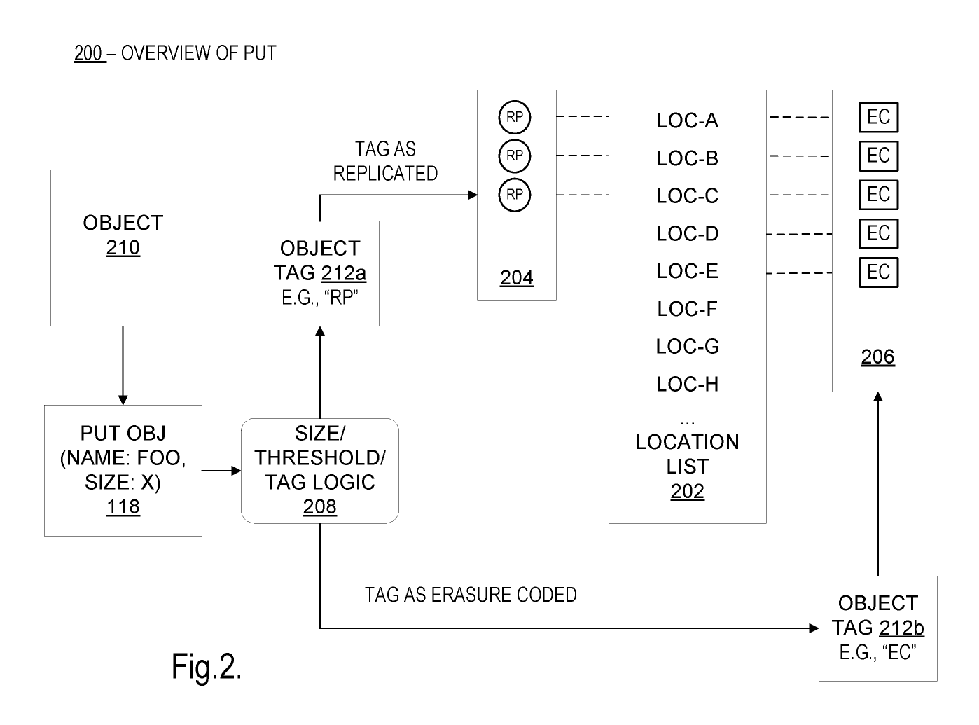

FIG. 2 illustrates an overview 200 of a PUT operation carried out in accordance with a system for multiple data protection schemes in a single namespace in accordance with one embodiment.

For example, an object 210 is received in a multiple data protection scheme logic 104 by way of a PUT operation 118, identified as object FOO having size X. A size/threshold/tag logic 208 component of multiple data protection scheme logic 104 processes object 210 to determine whether to tag the object with “RP” tag 212a for replicated objects, or with EC tag 212b for erasure coded objects.

In one embodiment, for either RP or EC objects, the object is stored at locations 204/206 specified in a same location list 202. In other words, both types of objects obtain the locations at which they are to be stored from the same location list 202.

In one embodiment, the location list 202 is a deterministic ordered list of logical memory addresses identifying locations in a memory for a particular namespace. In the illustrated embodiment, the location list 202 has locations LOC-A, LOC-B, LOC-C, LOC-E, LOC-F, LOC-G, LOC-H, and so forth. The location list 202 is obtained for the namespace through an object placement function. Examples of location lists obtained from object placement functions include a ring file using open source software such as Openstack's Swift, in which the ring file is a modified hashing ring to determine where data should reside in a cluster, and a CRUSH map using Ceph, in which a scalable pseudo-random data distribution function (the CRUSH function) maps data objects to storage objects with a uniform distribution of data across a cluster.

In one embodiment, while the list of locations is the same regardless of which data protection with which the object is tagged, the number of locations pulled from the location list 202 varies depending on the object 210 and the type of data protection with which the object is tagged. For example, the number of locations pulled from the location list 202 can be based on the number of replicas for an RP tagged object 212a or the number of erasure coded shards for an EC tagged object 212b. In the illustrated example, when object 210 is a replicated object the first three locations 204, LOC-A, LOC-B, LOC-C are obtained from location list 202 for the RP tagged object 212a to store three replicas of object 210. Likewise, when object 210 is an erasure coded object the first five locations 206, LOC-A, LOC-B, LOC-C, LOC-D, LOC-E are obtained from location list 202 for the EC tagged object 212b to store five shards for object 210. In one embodiment the tagged object 212a/212b can be tagged with an extra piece of metadata appended to the object 210 indicating whether the object is protected and, if so, whether the object is erasure coded or replicated.

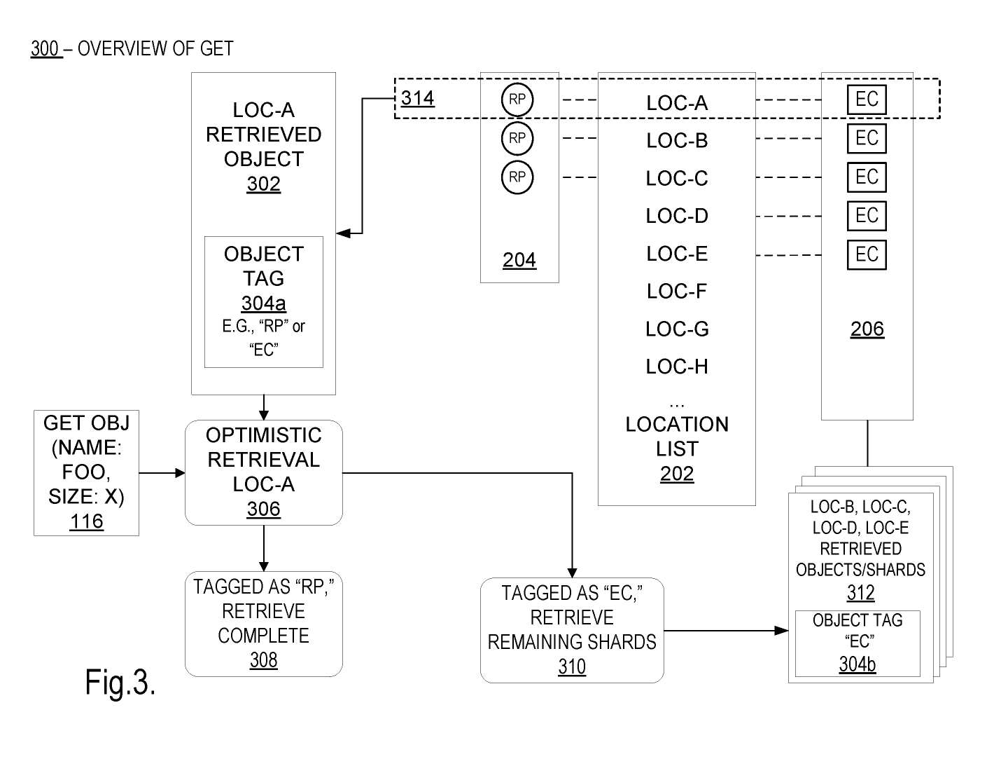

FIG. 3 illustrates an overview 300 of a GET operation carried out in accordance with a system for multiple data protection schemes in a single namespace in accordance with one embodiment.

For example, upon receiving a GET operation 116 to retrieve the specified object FOO, optimistic retrieval logic 306 of a multiple data protection scheme logic 104 optimistically retrieves the requested object 302 from LOC-A, the first location in the location list 202 for the single namespace. Retrieving the requested object 302 from the LOC-A, the first location in the location list 202, results in retrieval of either an RP object or an EC object 314. The LOC-A retrieved object 302, previously tagged with object tag 304a (from 212a/212b in FIG. 2) is examined upon retrieval to determine whether the object is tagged as RP 308 or EC 310. For example, object tag 304a can be an extra piece of metadata appended to the object 314 indicating whether the object is protected and, if so, whether the object is erasure coded or replicated. Additional locations 204/206 corresponding to the remaining locations in the list of locations 202, if needed, are used to retrieve any additional objects to complete the GET operation 116. The number of additional locations required to retrieve an object can be determined based on the type of data protection. For example, the number of replications when using replication RP data protection can be configured for the namespace and/or object storage system.

Likewise the number of shards used for erasure coding EC data protection can be configured for the namespace and/or object storage system. For example, in one embodiment, if tagged as EC, optimistic retrieval logic 306 of a multiple data protection scheme logic 104 determines whether to retrieve four additional shards 312 tagged as EC 304b from subsequent locations 206 corresponding to the list of locations 202, LOC-B, LOC-C, LOC-D, and LOC-E.

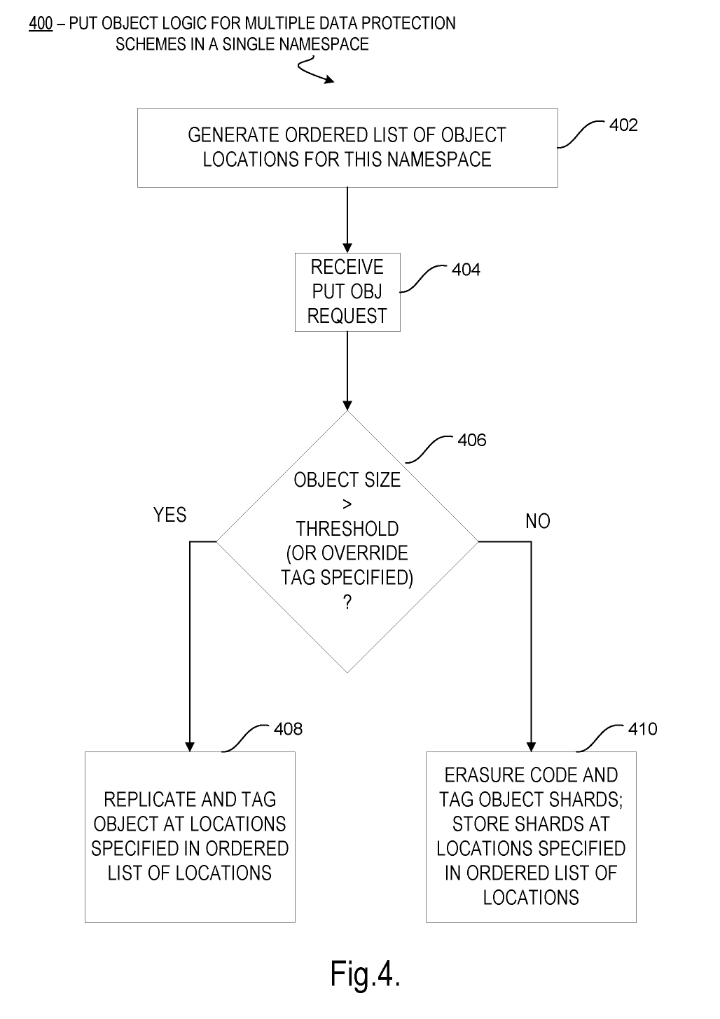

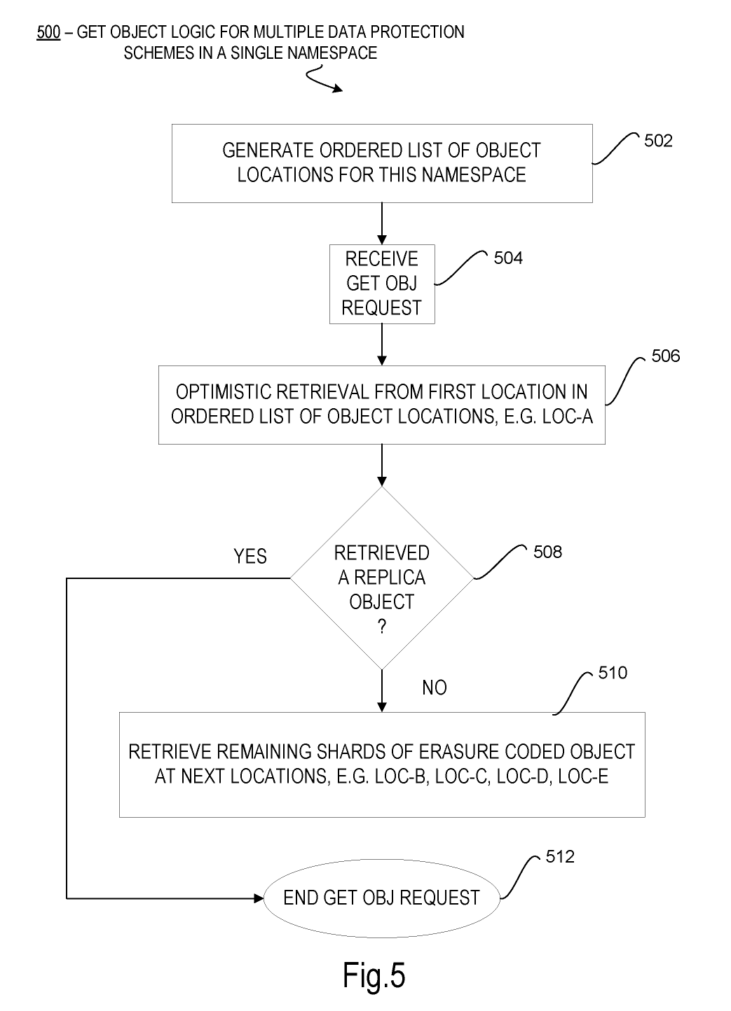

FIGS. 4-5 are flow diagrams illustrating a high-level overview of processing logic performed in a processor of an object storage system and/or an application interoperating with the object storage system and in accordance with embodiments of a system for multiple data protection in a single namespace as shown in FIGS. 1-3.

FIG. 4 illustrates a summary overview of a process 400 for the PUT object logic for storing/uploading objects using multiple data protection schemes in a single namespace. In one embodiment the process, at 402, prepares for storing/uploading by generating the ordered list of locations at which objects can be stored/uploaded for a given namespace.

In one embodiment, the ordered list is created based on object placement functions. The ordered list functions as a list of targets for storing an object identified in a PUT operation. The choice of object placement function does not matter, so long as it deterministically generates the same list for the same object identifier.

In one embodiment, the process 400 uses the same list of locations to store objects irrespective of the object's data protection. Also, the process 400 uses the locations in the list in the same order irrespective of the object's data protection. In one embodiment, the number of locations from the list that are used to store a particular object can vary depending on the object, including the object's data protection. In one embodiment, to ensure load balance of the placement of protected objects in the namespace the process 400 uses additional hashing to place objects pseudo-randomly within the list of locations created based on the placement function.

In one embodiment, at 404, the process receives the PUT object request to store/upload an object and continues at decision block 406 to perform a process to determine whether the object's size is greater than a predetermined threshold. In a typical embodiment, the processor can quickly identify the size of an object on upload. For example, the size can be included in object headers or metadata appended to the object on upload of the object into memory, or checked as a highwater mark or cutoff object size when buffering on upload of the object into memory. In one embodiment the threshold can be set from any source, such as a fixed configuration by an administrator, or input from a storage analytics systems.

In one embodiment a larger object size is encoded with a space-efficient data protection such as the erasure coding 410, whereas a smaller object size is encoded with processing-efficient data protection such as replication 408. Regardless of how the object is tagged for data protection, the process 400 completes the PUT operation at 408/410 by storing the objects at locations obtained in order from the same ordered list of locations and in accordance with their respective data protection. For example, if the data protection is tagged as RP for replication, the number of locations obtained from the list will depend on the number of replicas specified for this namespace, e.g. 3 replicas per object with one location per replica. If the data protection is tagged as EC for erasure coding, the number of locations obtained from the list will depend on the parameters set for erasure coding, e.g. 14 shards per object with one location per shard for erasure coding parameters k+m, where k=10 and m=4, referred to as a 10+4 erasure coding scheme.

In one embodiment, at decision block 406 the process also determines whether there is an override flag specified for this object, where the override flag dictates whether and/or which data protection to use for tagging and storing/uploading the object regardless of the object's size. For example, in one embodiment, the override flag can be stored as metadata appended to the object to which it pertains. In one embodiment the override flag can be a user-provided setting for objects, such as an administrative setting for the object storage system configured by a storage system administrator.

FIG. 5 illustrates a summary overview of a process 500 for the GET object logic for retrieving/downloading objects using multiple data protection schemes in a single namespace. In one embodiment the process, at 502, prepares for retrieving/downloading by generating the ordered list of locations at which objects can be retrieved/downloaded for a given namespace.

In one embodiment, at 504, the process receives a GET object request to retrieve/download an object and continues at 506 to perform a process to optimistically retrieve the object from the first location specified in the list of locations that was used to store/upload the objects, e.g. LOC-A in the examples illustrated in FIGS. 2-3. The retrieval is considered optimistic because the process 500 assumes that there is a greater likelihood that the object being requested is a replicated object, as statistically most stored objects are likely to be small and thus replicated, and that only one replica need be retrieved to satisfy the GET object request.

In one embodiment, at decision block 508, the process determines whether, in fact, the object that was retrieved at the first location is a replicated object, and that only one replica is needed. If the assumption was correct, then the GET object processing is complete.

In one embodiment, if the object that was retrieved at the first location is not a replicated object, but rather an erasure coded object, then at 510 the process determines how many remaining shards of the requested erasure coded object are needed, and initiates retrieval of the remaining shards at the next locations in the list of locations, e.g. LOC-B, LOC-C, LOC-D, LOC-E, for an object for which 5 shards are needed in order to reconstruct the entire object. Process 500 ends at 512, and is repeated beginning at 502 for each GET object request that is received.

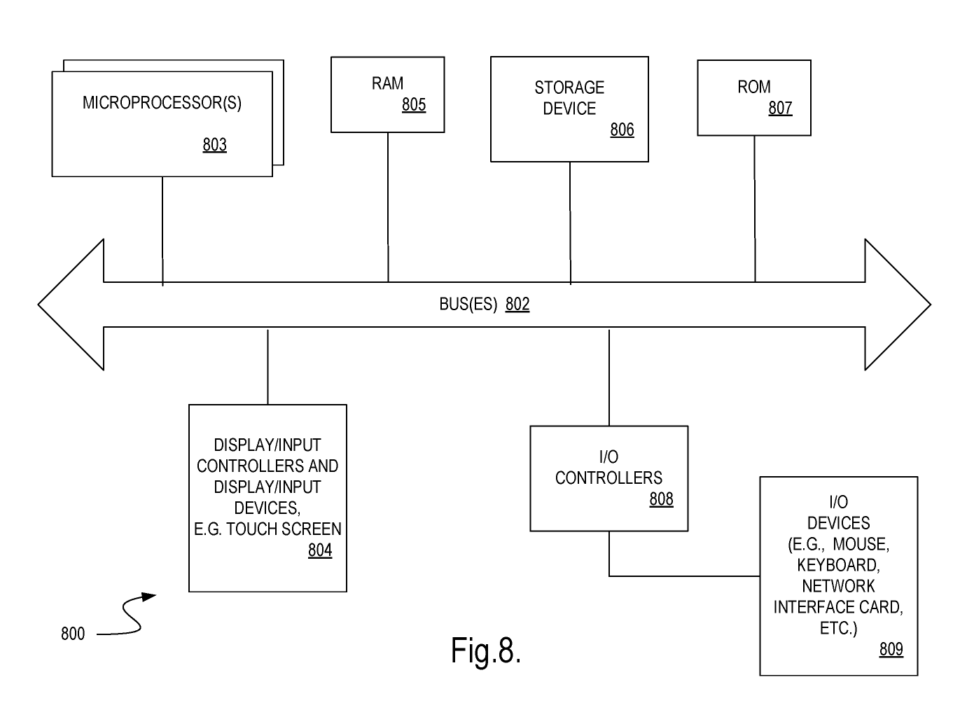

FIG. 8 illustrates an example of a typical computer system that can be used in conjunction with the embodiments described herein. Note that while FIG. 8 illustrates the various components of a data processing system 800, such as a computer system, it is not intended to represent any particular architecture or manner of interconnecting the components as such details are not germane to the described embodiments. It will also be appreciated that other types of data processing systems that have fewer components than shown or more components than shown in FIG. 8 could also be used with the described embodiments. The data processing system of FIG. 8 can be any type of computing device suitable for use as a forwarding device, switch, client, server and the like, of a storage management system. As shown in FIG. 8, the data processing system 800 includes one or more buses 802 that serve to interconnect the various components of the system. One or more processors 803 are coupled to the one or more buses 802 as is known in the art. Memory 805 can be DRAM or non-volatile RAM or can be flash memory or other types of memory described elsewhere in this application. This memory is coupled to the one or more buses 802 using techniques known in the art. The data processing system 800 can also include non-volatile memory, including ROM memory 807 and/or a storage device 806, such as a hard disk drive, solid state drive (SSD) or a flash memory or a magnetic optical drive or magnetic memory or an optical drive or other types of memory systems, all of which maintain data even after power is removed from the system. The non-volatile memory, such as ROM 807 and storage device(s) 806, and the memory 805 are coupled to the one or more buses 802 using known interfaces and connection techniques.

A display controller 804 is coupled to the one or more buses 802 in order to receive display data to be displayed on a display device 804 which can display any one of the user interface features or embodiments described herein. The display device 804 can include an integrated touch input to provide a touch screen.

The data processing system 800 can also include one or more input/output (I/O) controllers 808 which provide interfaces for one or more I/O devices, such as one or more mice, touch screens, touch pads, joysticks, and other input devices including those known in the art and output devices (e.g. speakers). The input/output devices 809 are coupled through one or more I/O controllers 808 as is known in the art.

While FIG. 8 shows that the non-volatile memory 807 and the memory 805 are coupled to the one or more buses directly rather than through a network interface, it will be appreciated that the data processing system may utilize a non-volatile memory which is remote from the system, such as a network storage device 806 which is coupled to the data processing system through a network interface such as a modem or Ethernet interface or wireless interface, such as a wireless WiFi transceiver or a wireless cellular telephone transceiver or a combination of such transceivers.

As is known in the art, the one or more buses 802 may include one or more bridges or controllers or adapters to interconnect between various buses. In one embodiment, the I/O controller 808 includes a Universal Serial Bus (USB) adapter for controlling USB peripherals and can control an Ethernet port or a wireless transceiver or combination of wireless transceivers.

It will be apparent from this description that aspects of the described embodiments could be implemented, at least in part, in software. That is, the techniques and methods described herein could be carried out in a data processing system in response to its processor executing a sequence of instructions contained in a tangible, non-transitory memory such as the memory 805 or the non-volatile memory 807 or a combination of such memories, and each of these memories is a form of a machine readable, tangible storage medium.

Hardwired circuitry could be used in combination with software instructions to implement the various embodiments. Thus the techniques are not limited to any specific combination of hardware circuitry and software or to any particular source for the instructions executed by the data processing system.

All or a portion of the described embodiments can be implemented with logic circuitry such as a dedicated logic circuit or with a microcontroller or other form of processing core that executes program code instructions. Thus processes taught by the discussion above could be performed with program code such as machine-executable instructions that cause a machine that executes these instructions to perform certain functions. In this context, a “machine” is typically a machine that converts intermediate form (or “abstract”) instructions into processor specific instructions (e.g. an abstract execution environment such as a “virtual machine” (e.g. a Java Virtual Machine), an interpreter, a Common Language Runtime, a high-level language virtual machine, etc.), and/or, electronic circuitry disposed on a semiconductor chip (e.g. “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture can be used to store program code. An article of manufacture that stores program code can be embodied as, but is not limited to, one or more memories (e.g. one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g. a server) to a requesting computer (e.g. a client) by way of data signals embodied in a propagation medium (e.g. via a communication link (e.g. a network connection)).

The term “memory” as used herein is intended to encompass all volatile storage media, such as dynamic random access memory (DRAM) and static RAM (SRAM) or other types of memory described elsewhere in this application. Computer-executable instructions can be stored on non-volatile storage devices, such as magnetic hard disk, an optical disk, and are typically written, by a direct memory access process, into memory during execution of software by a processor. One of skill in the art will immediately recognize that the term “machine-readable storage medium” includes any type of volatile or non-volatile storage device that is accessible by a processor.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The described embodiments also relate to an apparatus for performing the operations described herein. This apparatus can be specially constructed for the required purpose, or it may comprise a general-purpose computer selectively activated or reconfigured by a computer program stored in the computer. Either way, the apparatus provides the means for carrying out the operations described herein. The computer program can be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems can be used with programs in accordance with the teachings herein, or it may prove convenient to construct a more specialized apparatus to perform the operations described. The required structure for a variety of these systems will be evident from the description provided in this application. In addition, the embodiments are not described with reference to any particular programming language. It will be appreciated that a variety of programming languages could be used to implement the teachings of the embodiments as described herein.

In the foregoing specification, embodiments have been described with reference to specific exemplary embodiments. It will be evident that various modifications could be made to the described embodiments without departing from the broader spirit and scope of the embodiments as set forth in the following claims. The specification and drawings are, accordingly, to be regarded in an illustrative sense rather than a restrictive sense.

What is claimed is:

1. A computer-implemented method comprising:
in a processor of a storage system for storing objects, the processor in communication with an application operating on objects in a namespace by name:
configuring a data protection policy for storing objects protected with different data protection schemes in the namespace;
generating a set of locations for use with the namespace, the set of locations for operating on objects irrespective of which of the different data protection schemes protect the objects; and
managing requests from the application operating on objects in the namespace, including requests to store and retrieve objects in accordance with the configured data protection policy for objects protected with different data protection schemes in the namespace.

2. The computer-implemented method of claim 1, wherein configuring the data protection policy for objects protected with different data protection schemes in the namespace includes:
receiving a specification of each one of multiple data protection schemes enabled for use in the namespace, including a threshold size of objects governing which one of multiple data protection schemes to use for encoding and decoding objects.

3. The computer-implemented method of claim 2, wherein configuring a data protection policy for objects protected with different data protection schemes in the namespace further includes:
specifying an indicator for overriding the threshold size of objects that would otherwise govern which one of the multiple data protection schemes to use for encoding and decoding objects in the storage system, the indicator specifying none or a particular one of the multiple data protection schemes.

4. The computer-implemented method of claim 1, further comprising:
receiving a request to use an object in the namespace; and
selecting an object placement function for generating a same set of locations for the object each time the object is used in the namespace.

5. The computer-implemented method of claim 4, further comprising:
load-balancing the processing of the object for the namespace, including generating additional hashing of the set of locations generated for the object to place the object pseudo-randomly within the same set of locations.

6. The computer-implemented method of claim 4, wherein the request to use the object in the namespace is to store the object in the storage system, the method further comprising:
inspecting a size of the object;
comparing the size of the object with the a threshold size of objects governing which one of the multiple data protection schemes to use for storing objects in the storage system;
tagging the object with a selected one of the multiple data protection schemes based on whether the compared size of the object is within or exceeds the threshold size; and
storing the object using the same set of locations generated for the object and in accordance with the selected one of the multiple data protection schemes with which the object is tagged.

7. The computer-implemented method of claim 6, wherein objects within the threshold size use one of the multiple data protection schemes favoring more efficient processor performance over increased storage costs and objects exceeding the threshold size use one of the multiple data protection schemes favoring decreased storage costs over less efficient processor performance.

8. The computer-implemented method of claim 7, wherein the selected one of the multiple data protection schemes favoring more efficient processor performance over increased storage costs is replication.

9. The computer-implemented method of claim 7, wherein the selected one of the multiple data protection schemes favoring decreased storage costs over less efficient processor performance is erasure coding.

10. The computer-implemented method of claim 4, wherein the request to use the object in the namespace is to retrieve the object from the object storage system, the method further comprising:
retrieving the object specified in the request from one of a first number of locations in the same set of locations generated for the object, wherein the first number of locations is any one of a number of possible replicas or a number of possible shards for the object;
determining which one of the multiple data protection schemes with which the object is tagged; and
retrieving only if necessary any one or more additional objects related to the retrieved object, wherein retrieving only if necessary is based on the determined one of the multiple data protection schemes with which the object is tagged.

11. The computer-implemented method of claim 10, wherein the determined one of the multiple data protection schemes with which the object is tagged is erasure coding and the any one or more additional objects related to the retrieved object are shards necessary for reconstructing data for the object stored using erasure decoding.

12. A system comprising:
an object store to store objects encoded with or capable of being encoded with different ones of a plurality of data protection schemes;
a namespace for accessing objects in the object store by name; and
a processor in communication with one or more applications operating on objects in the namespace, the processor configured to:
identify one of the plurality of data protection schemes with which an object is efficiently encoded,
generate a set of locations for use with the namespace, the set of locations to operate on the object irrespective of the identified one of the plurality of data protection schemes with which the object is efficiently encoded, and
manage a request from the one or more applications to operate on the object in the namespace according to the identified one of the plurality of data protection schemes with which the object is efficiently encoded.

13. The system of claim 12, the processor further configured to:
receive any one or more pre-defined threshold sizes of objects used to identify ones of the plurality of data protection schemes with which objects are efficiently encoded; and
wherein to identify one of the plurality of data protection schemes with which an object is efficiently encoded, the processor is further configured to:
inspect a size of the object,
compare the size of the object with a pre-defined threshold size, and
tag the object with a selected one of the plurality of data protection schemes based on whether the compared size of the object is within or exceeds the pre-defined threshold size.

14. The system of claim 13, wherein data protection schemes with which an object is efficiently encoded include:
data protection schemes favoring more efficient processor performance over increased storage costs, and
data protection schemes favoring decreased storage costs over less efficient processor performance; and
wherein objects whose compared size is within the pre-defined threshold size use one of the plurality of data protection schemes favoring more efficient processor performance over increased storage costs and objects whose compared size exceeds the threshold size use one of the plurality of data protection schemes favoring decreased storage costs over less efficient processor performance.

15. The system of claim 14, wherein:
data protection schemes favoring more efficient processor performance over increased storage costs include replication; and
data protection schemes favoring decreased storage costs over less efficient processor performance include erasure coding.

16. The system of claim 13, the processor further configured to:
receive an override indicator to override the any one or more pre-defined threshold sizes of objects that would otherwise identify the one of the plurality of data protection schemes with which an object is efficiently encoded, the override indicator specifying none or a particular one of the plurality of data protection schemes to use instead of the identified one of the plurality of data protection schemes.

17. The system of claim 12, wherein to generate a set of locations for use with the single namespace, the set of locations for operating on the object irrespective of the identified one of the plurality of data protection schemes with which the object is efficiently encoded, the processor is further configured to select an object placement function to generate a same set of locations for use with the single namespace every time the application uses the object.

18. The system of claim 16, wherein the processor is further configured to:
load-balance the application's use of the object, including generating additional hashing of the same set of locations to place the object pseudo-randomly within the same set of locations.

19. The system of claim 12, wherein to manage requests from the application to operate on the object in the single namespace according to the identified one of the plurality of data protection schemes with which the object is efficiently encoded, the processor is further configured to:
receive a request from one or more applications to any one of access and retrieve the object in the single namespace; and
process the received request using the generated set of locations for use with the single namespace according to the identified one of the plurality of data protection schemes with which the object is efficiently encoded.

20. The system of claim 18, further wherein:
the request to retrieve the object in the single namespace is to retrieve the object from one of a first number of locations in the generated set of locations, wherein the first number of locations is any one of a number of possible replicas or a number of possible shards for the object, the processor further configured to:
determine which one of the plurality of data protection schemes with which the object is tagged; and
retrieve only if necessary any one or more additional objects related to the retrieved object, wherein retrieving only if necessary is based on the determined one of the plurality of data protection schemes with which the object is tagged.

21. The system of claim 20 wherein the determined one of the plurality of data protection schemes with which the object is tagged is erasure coding and the any one or more additional objects related to the retrieved object are shards necessary for reconstructing data for the object stored using erasure decoding.

22. At least one computer-readable non-transitory storage medium including instructions that, when executed on a processor, cause the processor to:
configure a data protection policy for storing objects protected with different data protection schemes in a namespace;
generate a set of locations for use with the namespace, the set of locations for operating on objects irrespective of their data protection; and
manage requests from the application operating on objects in the namespace, including requests to store and retrieve objects in accordance with the configured data protection policy for objects protected with different data protection schemes in the namespace.

23. The at least one computer-readable non-transitory storage medium of claim 22 wherein to configure the data protection policy for objects protected with different data protection schemes in the namespace includes instructions causing the processor to:
receive a specification of each one of multiple data protection schemes enabled for use in the namespace, including a threshold size of objects governing which one of multiple data protection schemes to use for objects in the storage system;
receive an indicator for overriding the threshold size of objects that would otherwise govern which one of the multiple data protection schemes to use for encoding and decoding objects in the storage system, the indicator specifying none or a particular one of the multiple data protection schemes; and
select an object placement function for generating a same set of locations for an object each time the object is used in the namespace.

24. The at least one computer-readable non-transitory storage medium of claim 23 wherein requests to store objects in the namespace includes instructions causing the processor to:
inspect a size of an object specified in the requests;
compare the size of the object with the threshold size of objects governing which one of the multiple data protection schemes to use for storing objects in the storage system;
tag the object with a selected one of the multiple data protection schemes based on whether the compared size of the object is within or exceeds the threshold size; and
store the object using the same set of locations generated for the object and in accordance with the selected one of the multiple data protection schemes with which the object is tagged.

25. The at least one computer-readable non-transitory storage medium of claim 24 wherein:
objects within the threshold size use one of the multiple data protection schemes favoring more efficient processor performance over increased storage costs, including replication; and
objects exceeding the threshold size use one of the multiple data protection schemes favoring decreased storage costs over less efficient processor performance.

26. The at least one computer-readable non-transitory storage medium of claim 24 wherein requests to retrieve objects in the namespace include instructions causing the processor to:
retrieve the object specified in the request from one of a first number of locations in the same set of locations generated for the object, wherein the first number of locations is any one of a number of possible replicas or a number of possible shards for the object;
determine which one of the multiple data protection schemes with which the object is tagged; and
retrieve only if necessary any one or more additional objects related to the retrieved object, wherein retrieving only if necessary is based on the determined one of the multiple data protection schemes with which the object is tagged.

27. The at least one computer-readable non-transitory storage medium of claim 26 wherein the determined one of the multiple data protection schemes with which the object is tagged is erasure coding and the any one or more additional objects related to the retrieved object are shards necessary for reconstructing data for the object stored using erasure decoding.
